(19) United States
(12) Patent Application Publication
(10) Pub. No.: US 2002/0153853 A1
(43) Pub. Date: Oct. 24, 2002

(54) Method and device for protecting voltage power supplies used in a cathode ray tube manufacturing process

(75) Inventor: David Allen Murtishaw, Sun City, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation and Sony Electronics Inc.

(21) Appl. No.: 09/839,717

(22) Filed: Apr. 20, 2001

(51) Int. Cl. H01J 1/52

(52) U.S. Cl. 315/411

(57) ABSTRACT

High-voltage power supplies used in a Cathode Ray Tube (“CRT”) manufacturing process should be protected from residue, dust and other contaminants. This will prevent possible damage to the voltage power supply and danger to people and equipment that can result from operation of a dirty voltage power supply. A protective housing made of a non-conductive, insulating material is used to encase and protect the voltage power supplies used in a CRT manufacturing process. This protective housing protects those voltage power supplies from degradation or damage due to the dust, residue or other contaminants that arise from the CRT manufacturing process. A cooling system may be incorporated into the housing to manage thermal energy generated by the voltage power supply unit.

### FIELD OF THE INVENTION

The present invention relates to the field of cathode ray tube manufacture. More specifically, the present invention relates to a method and device for protecting the high-voltage power supplies used in the cathode ray tube manufacturing process. The present invention provides an insulated housing in which the high-voltage power supply is housed to prevent damage to or degradation of the voltage power supply.

### BACKGROUND OF THE INVENTION

Cathode ray tubes (“CRTs”) are well known in modem society. The CRT is the principal component in such common devices as television sets and computer and video monitors. As shown in FIG. 1, a CRT (100) typically includes a relatively flat display portion (101) (upper portion as seen in FIG. 1). When one is watching television or looking at a computer monitor, that person is looking at the flat display portion (101) of a cathode ray tube. Below the display portion (101) is a funnel portion (102) that narrows into the “neck” of the CRT.

During manufacture, layers of carbon material are coated on the interior of the CRT funnel (102). Also, an electro-luminescent material such as phosphorus is coated over the display portion (101) of the CRT.

The display portion (101) is then joined to the funnel (102) using a glass paste compound known as frit. A bead of frit is distributed around the interface between the funnel (102) and the display portion (101). The frit is the cured or hardened to form an airtight seal between the display portion (101) and the funnel (102). This seal may be referred to as a frit seal (103).

An electron gun is then placed at the end of the CRT's “neck” (102). When the CRT is operated, a yoke (not shown) creates an electromagnetic field and causes the stream of electrons emitted from the electron gun to scan in lines across the surface of the display portion (101). Where the stream of electrons hits the electro-luminescent material, the electro-luminescent material emits light. Thus, by rapidly switching the electron stream on and off, or by varying the power of the electron stream as it sweeps across the display portion of the CRT, an image can be formed in the light emitted by the electro-luminescent material. This is the general principle on which CRTs operate.

There are a number of points during the manufacture of a CRT that application of a high-voltage is required. The voltage may be used to test or operate the components of the CRT under production. For example, after the display portion (101) of the tube is joined to the funnel (102) and the joint between the two is sealed with frit, the completed tube is evacuated. Then, the strength of the frit seal (103) and the integrity of the vacuum are evaluated by applying a high-voltage to the anode or funnel portion (102) of the CRT. This evaluation is known as “frit knocking.” Obviously, a voltage power supply is required to generate the voltage applied to the CRT during frit knocking.

While voltage power sources are required to provide the necessary voltages used during the CRT manufacturing process, it is also difficult to maintain voltage power supplies in the environment of a CRT manufacturing process. The CRT manufacturing process inherently generates residues, dust and other contaminants that frequently lodge on voltage power supplies used in the manufacturing process.

As the voltage power supply becomes dirty and contaminated, its operation is degraded. Specifically, dirt and residue on a voltage power supply are the chief causes of external shorts of the voltage power supply and electrical arcing from the voltage power supply. Such shorts and arcing may cause damage to or destroy the voltage power supply or other equipment used in the CRT manufacturing process. Such shorting and arcing can also pose a danger to personnel working on the CRT production line.

Consequently, there is a need in the art for a device and method for protecting the high-voltage power supplies used in a CRT manufacturing process from residue, dust and other contaminants so as to prevent damage to the voltage power supply and danger to people and equipment that can result from operation of a dirty voltage power supply. Such a device or method must still allow the voltage power supply to be used as necessary to supply voltages used in the CRT manufacturing process.

### SUMMARY OF THE INVENTION

The present invention meets the above-described needs and others. Specifically, the present invention provides a device and method for protecting the high-voltage power supplies used in a CRT manufacturing process from residue, dust and other contaminants so as to prevent damage to the voltage power supply and danger to people and equipment that can result from operation of a dirty voltage power supply.

Additional advantages and novel features of the invention will be set forth in the description which follows or may be learned by those skilled in the art through reading these materials or practicing the invention. The advantages of the invention may be obtained and achieved through the means recited in the attached claims.

The present invention may be embodied and described as a protective system for a voltage power supply used in a cathode ray tube manufacturing process. This system preferably includes a protective housing sized and shaped for enclosing the voltage power supply in an interior that is protected from contamination associated with the cathode ray tube manufacturing process; and the voltage power supply housed in the protective housing.

The housing preferably includes an opening through which an output line of the voltage power supply exits the interior of the housing. This opening is preferably protected by a grommet that creates a seal with the output line. The housing preferably also includes a second opening through which a power line runs to the voltage power supply. Again, this second opening is preferably protected by a grommet that creates a seal with the power line.

The housing may further include a hinged lid to allow ready access to the interior of the housing and the voltage power supply protected therein. The housing may also include a latch for securing the lid.

If heat build-up is a potential problem, the housing may also include a cooling system. Preferably, the cooling system includes a coil in the housing through which coolant is circulated by a coolant circulation system.

The present invention also encompasses the methods of making and using the protective housing described above. Specifically, the present invention may encompass a method for protecting a voltage power supply used in a cathode ray tube manufacturing process from contamination associated with the cathode ray tube manufacturing system by enclosing the voltage power supply in a protective housing, the voltage power supply being placed in the interior of the protective housing so as to protect the voltage power supply from contamination associated with the cathode ray tube manufacturing process. The method of the present invention may also include using the enclosed voltage power supply housed in the protective housing in a cathode ray tube manufacturing process.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a cathode ray tube produced by a manufacturing process to which the present invention is applicable.

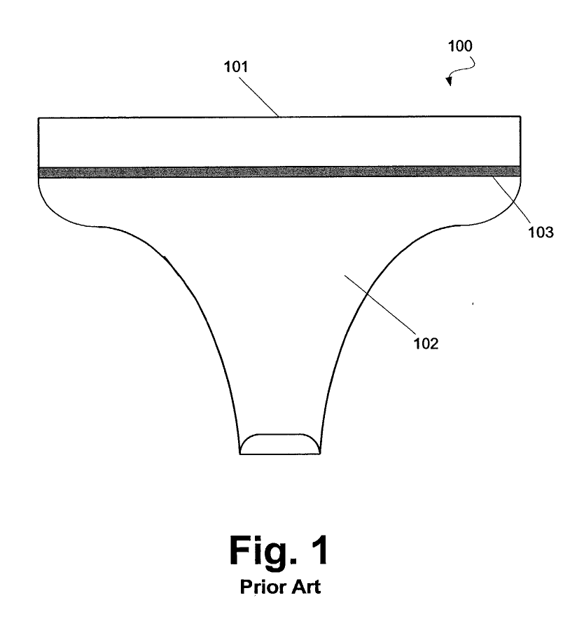

FIG. 2 is an illustration of a first embodiment of an insulated housing for a voltage power supply according to the present invention.

FIG. 3 is an illustration of a second embodiment of an insulated housing for a voltage power supply according to the present invention.

FIG. 4 is an illustration of a third embodiment of an insulated housing for a voltage power supply according to the present invention.

FIG. 5 is a flow chart illustrating a preferred embodiment of a method of the present invention.

Throughout the drawings, identical elements are designated by identical reference numbers.

### DETAILED DESCRIPTION OF THE PREFERRED EMBODIMENTS

The present invention provides a device and method for protecting the high-voltage power supplies used in a Cathode Ray Tube (“CRT”) manufacturing process from the residue, dust and other contaminants associated with a CRT manufacturing process. This protection of the voltage power supplies is provided so as to prevent damage to the voltage power supply and danger to people and equipment that can result from operation of a dirty voltage power supply.

Stated in broad principle, the present invention includes a protective housing made of a non-conductive, insulating material in which the voltage power supplies used in a CRT manufacturing process can be housed to protect those voltage power supplies from degradation or damage due to the dust, residue or other contaminants that arise from the CRT manufacturing process. The housing preferably provides ready access to the enclosed voltage power supply and contaminant-protected connections to and from the voltage power supply.

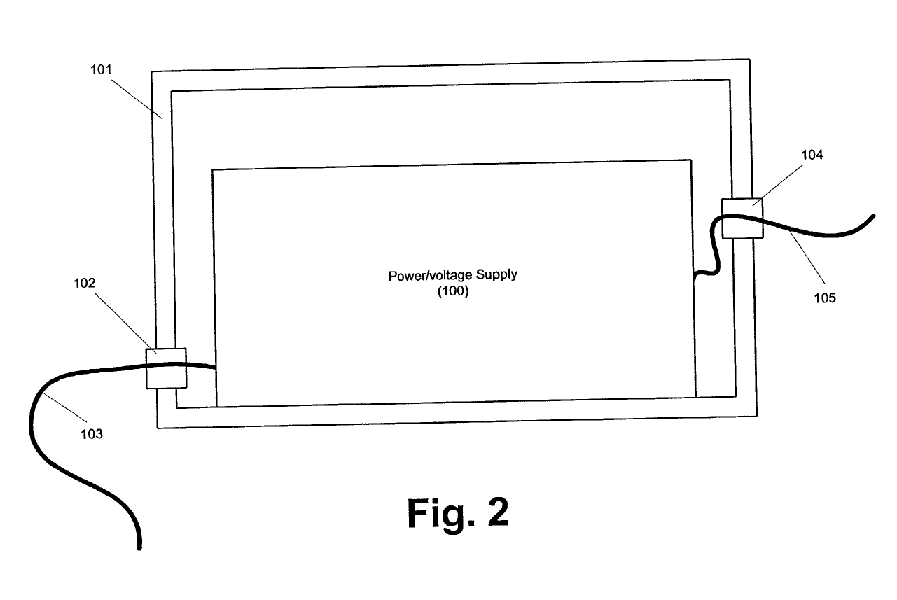

FIG. 2 illustrates a first embodiment of the present invention. As shown in FIG. 2, a high-voltage power supply (100) is provided for use in the various aspects of a CRT manufacturing process. The supply unit (100) has an output line (105) over which the desired voltage is provided to the manufacturing process. The supply unit (100) may also have a power line (103) to provide power from, for example, a wall outlet to operate the supply unit (100). The supply unit (100) may also include user controls (not shown) that allow the voltage or power output of the supply unit (100) to be adjusted and controlled.

FIG. 2 also illustrates that the high-voltage power supply (100) is enclosed in a protective housing (101). The housing (101) prevents any dust, dirt, residues or other contamination from reaching and lodging on the supply unit (100). Consequently, the supply unit (100) is not prone to the failure or damage described above that commonly occur in supply units used in the relatively dirty environment of a CRT manufacturing facility.

The housing (101) is preferably made of a non-conducting or insulating material. This is important to prevent potential arcing between the supply unit (100) and the housing (101). For example, the housing (101) can be made of a rubber, plastic, glass or ceramic material. However, any material that is not conductive and can shield the supply (100) from contamination can be used to form the housing (101).

The housing (101) includes an opening or openings through which the power line (103) and output line (105) connect to the supply unit (100) in the housing (101). Flexible grommets, preferably made of rubber, are used to create a seal in each opening around the power line (103) or the output line (105) so that dirt, dust, residues or other contaminants produced by the CRT manufacturing process can be kept from within the housing (101).

In the embodiment illustrated in FIG. 2, a first grommet (102) is placed in an opening through which the power line (103) passes and creates a seal around the power line (103). Similarly, a second grommet (104) is placed in an opening through which the output line (105) passes and creates a seal around the output line (105).

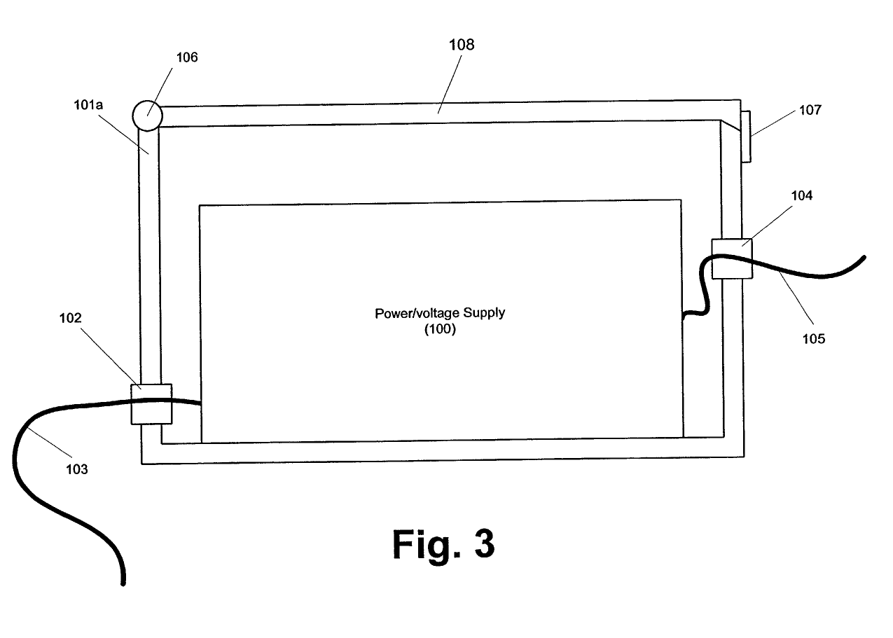

FIG. 3 illustrates additional features and details that may be provided in a housing (110a) according to a further embodiment of the present invention. As shown in FIG. 3, the housing (110a) may incorporate a lid (108) to allow easy access to the supply unit (100) in the housing (110a). The lid (108) may be friction fit to the housing (110a) or, as illustrated in the preferred embodiment of FIG. 3, may be hinged to the housing (110a) by a hinge (106).

Additionally, in the preferred embodiment of FIG. 3, the lid (108) may be latched to the housing (110a) when the lid (108) is closed. A latch (107) is provided to secure the lid (108) in a closed position over the housing (110a). The latch (107) helps ensure that the housing (110a) is not inadvertently opened thereby allowing contamination to reach the supply unit (100).

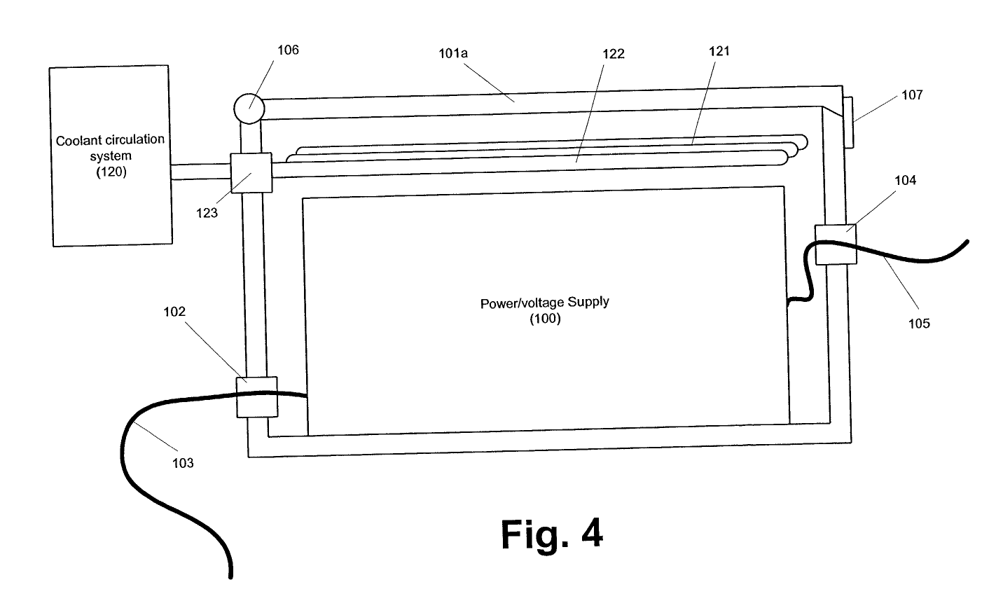

FIG. 4 illustrates a further preferred embodiment of the present invention. The embodiment of FIG. 4 address the situation in which a supply unit (100) may generate too much thermal energy to be safely enclosed in the protective housing (101a). Under the principles of the present invention, if the supply unit (100) produces too much heat to be safely enclosed in a protective housing, a cooling system may be included in the housing to prevent the heat given off by the supply unit from reaching temperatures at which the supply unit or housing are damaged or become unsafe.

A preferred method of incorporating a cooling system includes running a closed cooling system into the interior of the housing (101a), as illustrated in FIG. 4. A closed cooling system is preferred because a closed cooling system will not allow the introduction of dust, dirt or other contaminants into the protected environment inside the protective housing (110a). A preferred closed cooling system will be described in detail below.

However, alternative cooling systems, such as a fan or exhaust system could be used under the principles of the present invention. In such an alternative cooling system, attention would preferably be paid to preventing contamination from reaching the supply unit (100) through the cooling system. This may be done by, for example, a fan system that circulates air through the interior of the protective housing and which passes the air through a filtering or baffle system that removes airborne contaminants before the air enters the protective housing (110a) of the present invention.

A preferred closed cooling system is illustrated in detail in FIG. 4. This system includes a coil of tubing (121) within the protective housing (110a). A coolant (122) is circulated through the coil (121) by a coolant circulation system (120). The coolant (122) absorbs thermal energy inside the housing (110a). The coolant (122) is then circulated out of the housing (101a) where it is cooled to release the heat taken from inside the housing (110a). In this way, as the coolant (122) continues to circulate, the interior of the housing (110a) is maintained at a safe and optimal operating temperature.

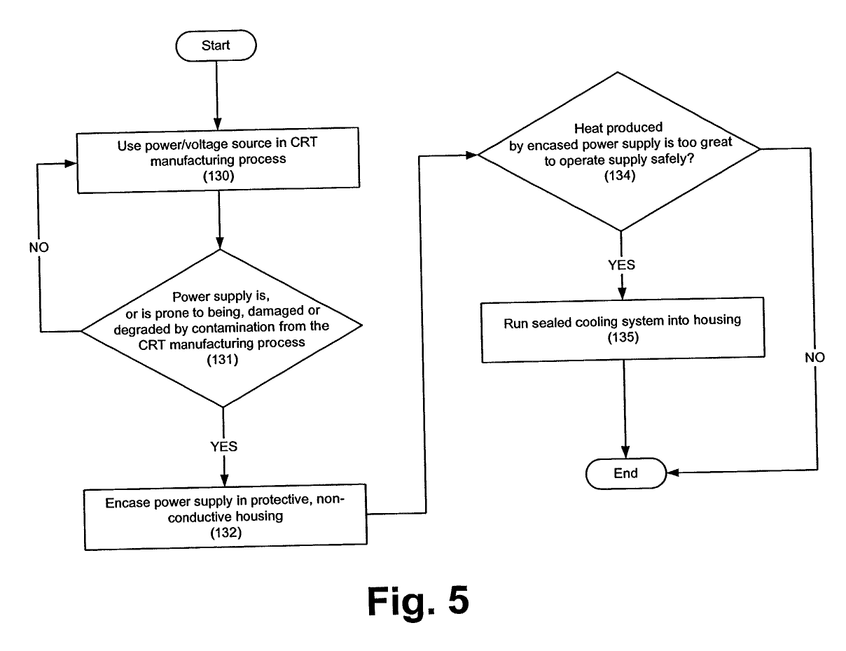

FIG. 5 is a flowchart illustrating a preferred method of implementing the principles of the present invention. The method illustrated in FIG. 5 is encompassed within the present invention.

As shown in FIG. 5, the method may begin when high-voltage power supplies are used in a CRT manufacturing process (130) and are, therefore, subject to damage or degradation due to the dust, dirt, residues and other contaminants that accompany the CRT manufacturing process. The circumstances under which each power supply is used should be evaluated to determine if that supply unit is prone to being damaged or degraded by contamination from the CRT manufacturing process (131).

If not, the supply unit may not need to be encased in a protective housing. However, if the supply unit is, in fact, prone to such damage and/or degradation, the decision may be made to encase the power supply in a protective, nonconductive housing (132). The preferred details of such a housing have been discussed above.

It should next be considered whether the ambient conditions under which the power supply unit is used, the settings of the power supply unit and the thermal energy produced by the power supply unit will result in an elevated temperature within the protective housing that will damage or degrade the operation of the power supply unit, or cause the power supply unit to operate in an unsafe manner (134). If not, the supply unit can be operated safely in the housing while profiting from the protection from contamination that the housing affords.

If the supply unit cannot be safely operated in the housing due to concerns of temperature build up, a cooling system can be incorporated into the housing (135). The details and possible types of such a cooling system are described above. Any system capable of reducing or maintaining the temperature inside the housing can be profitably used under the principles of the present invention.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A protective system for a voltage power supply used in a cathode ray tube manufacturing process, said system comprising:
a protective housing sized and shaped for enclosing said voltage power supply in an interior that is protected from contamination associated with said cathode ray tube manufacturing process.

2. The system of claim 1, further comprising said voltage power supply housed in said protective housing.

3. The system of claim 2, wherein said housing further comprises an opening through which an output line of said voltage power supply exits said interior.

4. The system of claim 3, wherein said opening is protected by a grommet that creates a seal with said output line.

5. The system of claim 3, wherein said housing further comprises a second opening through which a power line runs to said voltage power supply.

6. The system of claim 5, wherein said second opening is protected by a grommet that creates a seal with said power line.

7. The system of claim 1, wherein said housing further comprises a hinged lid.

8. The system of claim 7, wherein said housing further comprises a latch for securing said lid.

9. The system of claim 1, wherein said housing further comprises a cooling system.

10. The system of claim 9, wherein said cooling system comprises a coil in said housing through which coolant is circulated by a coolant circulation system.

11. The system of claim 1, wherein said housing is constructed of a non-conducting material.

12. A method for protecting a voltage power supply used in a cathode ray tube manufacturing process from contamination associated with said cathode ray tube manufacturing system, said method comprising:
enclosing said voltage power supply in a protective housing, said voltage power supply being placed in an interior of said protective housing so as to protect said voltage power supply from contamination associated with said cathode ray tube manufacturing process.

13. The method of claim 12, further comprising using said enclosed voltage power supply housed in said protective housing in said cathode ray tube manufacturing process.

14. The method of claim 12, further comprising preventing said contamination from entering an opening in said housing through which an output line of said voltage power supply exits said housing.

15. The method of claim 14, wherein said preventing contamination from entering said opening is performed by installing a grommet in said opening that creates a seal with said output line.

16. The method of claim 12, further comprising preventing said contamination from entering an opening in said housing through which a power line to said voltage power supply enters said housing.

17. The method of claim 16, wherein said preventing contamination from entering said opening is performed by installing a grommet in said opening that creates a seal with said power line.

18. The method of claim 12, further comprising accessing said interior of said housing by opening a hinged lid.

19. The method of claim 18, further comprising securing said lid with a latch when said lid is closed.

20. The method of claim 12, further comprising cooling said interior of said housing with a cooling system.

21. The method of claim 20, wherein said cooling said interior of said housing is performed with a coil in said housing through which coolant is circulated by a coolant circulation system.

22. A system for protecting a voltage power supply used in a cathode ray tube manufacturing process from contamination associated with said cathode ray tube manufacturing system, said system comprising:
means for enclosing said voltage power supply in a protected environment; and
means for using said enclosed voltage power supply enclosed in said protected environment in said cathode ray tube manufacturing process.

23. The system of claim 22, further comprising means for preventing said contamination from entering said protected environment through an opening through which an output line of said voltage power supply exits said protected environment.

24. The system of claim 22, further comprising means for preventing said contamination from entering said protected environment through an opening through which a power line to said voltage power supply enters said protected environment.

25. The system of claim 22, further comprising means for cooling said voltage power supply in said protected environment.

26. The system of claim 22, further comprising means for selectively accessing said voltage power supply in said protected environment.

27. The system of claim 22, wherein said means for enclosing said voltage power supply in a protected environment are constructed from an insulating material.
